(19) United States
(12) Patent Application Publication
(10) Pub. No.: US 2024/0380867 A1
(43) Pub. Date: Nov. 14, 2024

(54) FIRE ALARM SYSTEM WITH VISUAL VERIFICATION

(71) Applicant: Climax Technology Co., LTD., Taipei (TW)

(72) Inventor: Yi-Kai Chen, Taipei City (TW)

(21) Appl. No.: 18/196,969

(22) Filed: May 12, 2023

(51) Int. Cl. H04N 7/18; G08B 17/12

(52) U.S. Cl. CPC H04N 7/183; G08B 17/125

(57) ABSTRACT

A fire alarm system with visual verification includes an image capture device that generates a captured image representing a scene under monitoring; a fire detector that detects presence of fire, the fire detector activating the image capture device to generate a captured image representing the scene when the fire detector is triggered; and a security center that receives and processes the captured image. The captured image is immediately sent to the security center for visual verification before notifying fire fighters to evacuate and rescue.

### BACKGROUND OF THE INVENTION

### 1. Field of the Invention

The present invention generally relates to a fire alarm system, and more particularly to a fire alarm system and method with visual verification.

### 2. Description of Related Art

A fire alarm system is a set of devices that detect and alert people to the presence of smoke, fire, carbon monoxide or other fire-related emergencies. Fire alarms systems are required in most buildings and are installed to protect life and property. These devices may include fire detectors such as smoke detectors that sense smoke as an indicator of fire, heat detectors that detect change of temperature or actual temperature, fire gas detectors such as carbon monoxide (CO) detector that detect the presence of the carbon monoxide gas to prevent carbon monoxide poisoning, and flame detectors that detect and respond to the presence of a flame or fire.

The goal of the fire alarm system is to detect the presence of fire in the area using fire detectors, and then alert the fire department or security personnel to evacuate, extinguish and rescue on site. However, fire detector technology often leads to false alarms, which cause unnecessary disruptions and waste of resources. False alarms can be triggered by various factors, such as improper installation, environmental conditions, human actions or equipment malfunction.

A need has thus arisen to propose a novel scheme for the fire alarm system to accurately detect and report real fires, thereby prevent false alarms associated with the fire detectors.

### SUMMARY OF THE INVENTION

In view of the foregoing, it is an object of the embodiment of the present invention to provide a fire alarm system and method with visual verification capable of effectively avoiding false alarm associated with the fire detector.

According to one embodiment, a fire alarm system with visual verification includes an image capture device, a fire detector and a security center. The image capture device generates a captured image representing a scene under monitoring. The fire detector detects presence of fire, and the fire detector activates the image capture device to generate a captured image representing the scene when the fire detector is triggered. The security center receives and processes the captured image. The captured image is immediately sent to the security center for visual verification before notifying fire fighters to evacuate and rescue.

### BRIEF DESCRIPTION OF THE DRAWINGS

FIG. 1 shows a block diagram illustrating a fire alarm system with visual verification according to one embodiment of the present invention;

FIG. 2 shows a flow diagram illustrating a fire alarm method with visual verification adaptable to the alarm system of FIG. 1; and

FIG. 3 shows a schematic diagram illustrating a scene under monitoring by the fire alarm system of FIG. 1.

### DETAILED DESCRIPTION OF THE INVENTION

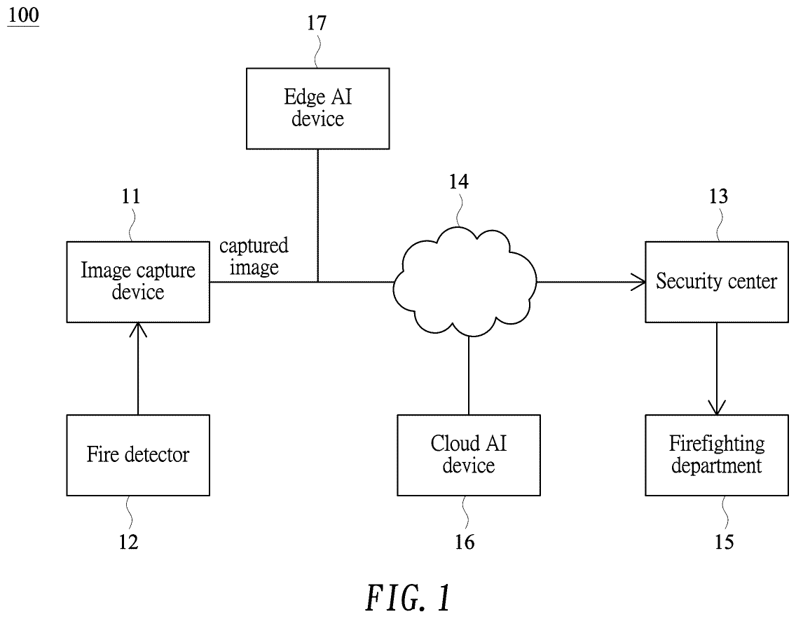

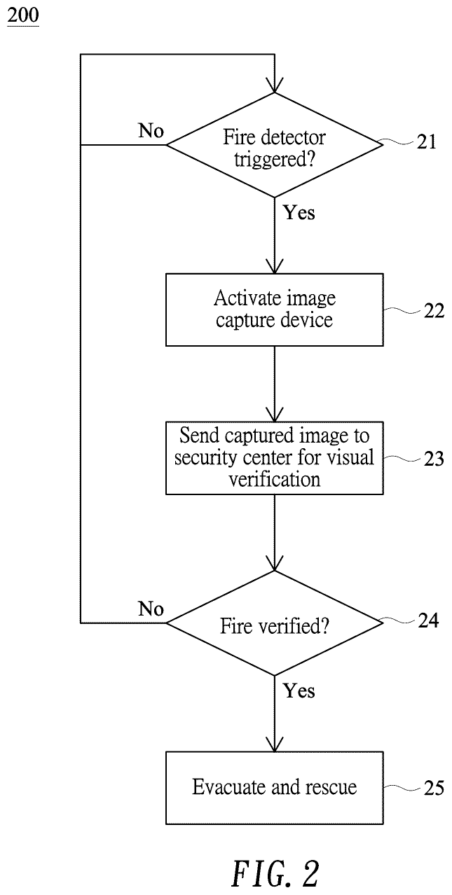

FIG. 1 shows a block diagram illustrating a fire alarm system with visual verification 100 (“fire alarm system” hereinafter) according to one embodiment of the present invention, and FIG. 2 shows a flow diagram illustrating a fire alarm method with visual verification 200 (“fire alarm method” hereinafter) adaptable to the alarm system 100 of FIG. 1.

In the embodiment, the fire alarm system 100 may include (at least) an image capture device 11, such as an image sensor, configured to convert light waves into a captured image representing a scene under monitoring. The fire alarm system 100 of the embodiment may include (at least) a fire detector 12 configured to detect presence of fire by monitoring signs of fire such as smoke, heat, infrared light radiation, ultraviolet light radiation or gas. In one embodiment, the fire detector 12 may include a smoke detector that senses smoke as an indicator of fire. In another embodiment, the fire detector 12 may include a heat detector that detects change of temperature or actual temperature.

When the fire detector 12 is triggered (step 21), that is, the smoke (in the smoke detector) or change of temperature or actual temperature (of the heat detector) reaches a predetermined level, the fire detector 12 activates (or turns on) the image capture device 11 to generate (at least) a captured image representing a scene under monitoring (step 22). It is noted that the image capture device 11 of the embodiment is normally turned off, and is turned on only when the fire detector 12 is triggered, thereby maintaining privacy and substantially reducing power consumption. Therefore, battery life of battery-powered fire detector 12 can be substantially improved, energy be greatly saved, and carbon emissions be considerably reduced.

The fire alarm system 100 of the embodiment may include a security center 13, as a central hub, configured to receive and process the captured image, for example, via the Internet 14, and notify a firefighting department 15 for required action.

In step 23, according to one aspect of the embodiment, the captured image (generated in step 22) is immediately sent, for example, via the Internet 14, to a security center 13 for visual verification before notifying fire fighters to evacuate and rescue. In other words, evacuation and rescue (step 25) proceed only when fire is verified (step 24) by the security center 13 according to the captured image, thereby avoiding false alarm associated with the fire detector 12. In addition to verifying the fire (according to the captured image), the security center 13 may further determine whether there are personnel on the scene according to the captured image. If there are personnel on the scene, the security center 13 may increase notification level for priority processing to facilitate faster on-site evacuation and rescue. In one embodiment, after verifying the fire (step 24), the image capture device 11 may be turned on continuously to capture a plurality of images, according to which the security center 13 may further determine whether there are still personnel on the scene and notify the fire fighters to evacuate and rescue if needed.

In one embodiment, the fire alarm system 100 may optionally include a cloud artificial intelligence (AI) device 16 or an edge artificial intelligence (AI) device 17 configured to perform image processing on the captured image to facilitate determining whether there are fire sources, smoke and/or personnel in the captured image, thereby substantially saving firefighting manpower and improving system response time. The cloud AI refers to the use of cloud computing platforms to perform AI-related tasks such as data processing, machine learning, and deep learning. Cloud AI services provided by major cloud providers can provide developers with access to pre-trained models, application programming interfaces (APIs) and tools that can be used to build intelligent applications. The edge AI refers to the deployment of AI applications in devices with AI computation being done close to where the data is located (i.e., the image captured device 11 in this case), rather than centrally in a cloud computing facility.

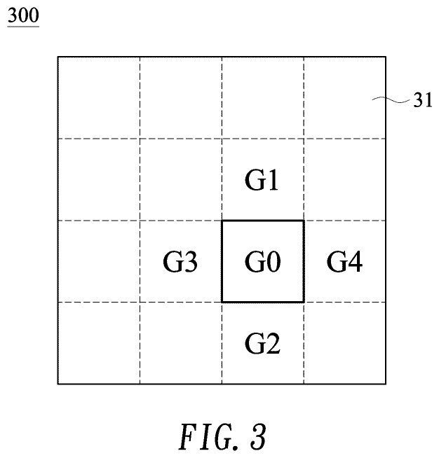

FIG. 3 shows a schematic diagram illustrating a scene 300 under monitoring by the fire alarm system 100 of FIG. 1. According to another aspect of the embodiment, the scene 300 may be divided into a plurality of groups (or units) 31 covering corresponding fire detectors 12 and corresponding image capture devices 11. When one fire detector 12 in an initial group (e.g., G0 as exemplified in FIG. 3) is triggered (step 21), fire detectors 12 in the same initial group G0 and adjacent group(s) (e.g., G1 to G4) may be activated to capture images to accordingly determine whether there are personnel on the scene, thereby facilitating evacuation and rescue of high-risk areas (i.e., groups) near the fire.

Although specific embodiments have been illustrated and described, it will be appreciated by those skilled in the art that various modifications may be made without departing from the scope of the present invention, which is intended to be limited solely by the appended claims.

What is claimed is:

1. A fire alarm system with visual verification, comprising:
an image capture device that generates a captured image representing a scene under monitoring;
a fire detector that detects presence of fire, the fire detector activating the image capture device to generate a captured image representing the scene when the fire detector is triggered; and
a security center that receives and processes the captured image;
wherein the captured image is immediately sent to the security center for visual verification before notifying fire fighters to evacuate and rescue.

2. The system of claim 1, wherein the image capture device comprises an image sensor.

3. The system of claim 1, wherein the fire detector comprises a smoke detector or a heat detector.

4. The system of claim 1, wherein the image capture device is turned on only when the fire detector is triggered.

5. The system of claim 1, wherein evacuation and rescue proceed only when fire is verified by the security center according to the captured image.

6. The system of claim 5, wherein the security center further determines whether there are personnel on the scene according to the captured image after verifying the fire.

7. The system of claim 6, wherein the image capture device is turned on continuously to capture a plurality of images after verifying the fire, according to which the security center further determines whether there are still personnel on the scene.

8. The system of claim 1, further comprising:
a cloud artificial intelligence (AI) device that performs image processing on the captured image to facilitate determining whether there are fire sources, smoke or personnel in the captured image.

9. The system of claim 1, further comprising:
an edge artificial intelligence (AI) device that performs image processing on the captured image to facilitate determining whether there are fire sources, smoke or personnel in the captured image.

10. The system of claim 1, wherein the scene is divided into a plurality of groups covering corresponding fire detectors and corresponding image capture devices.

11. The system of claim 10, wherein when one fire detector in an initial group is triggered, fire detectors in the initial group and adjacent groups are activated to capture images to accordingly determine whether there are personnel on the scene.
